(19) United States
(12) Patent Application Publication
(10) Pub. No.: US 2015/0291397 A1
(43) Pub. Date: Oct. 15, 2015

(54) LIFTER WITH ELECTROPERMANENT MAGNETS

(71) Applicant: SGM GANTRY S.P.A., Manerbio BS (IT)

(72) Inventor: Danilo Molteni, Manerbio BS (IT)

(73) Assignee: SGM Gantry S.p.A., Manerbio BS (IT)

(21) Appl. No.: 14/438,924

(22) PCT Filed: Nov. 14, 2013
(86) PCT No.: PCT/IB2013/060131

§ 371 Date: Apr. 28, 2015

(30) Foreign Application Priority Data
Nov. 30, 2012 (IT) MI2012A002047

(51) Int. Cl. B66C 1/06

(52) U.S. Cl. CPC B66C 1/06

(57) ABSTRACT

A lifter with electro-permanent magnets comprises an external bearing structure (2, 3) closed at the bottom by a plate, provided with a heat shield (9), from which the circuit poles (1) protrude with their pole pieces (5), each of the electro-permanent magnets being composed of a reversible magnet (6) arranged on top of one of said poles (1), of a fixed polarization magnet (7) formed by a plurality of blocks placed along the lateral faces of the pole (1) and of a coil (8) arranged around the reversible magnet (6) to cause the reversal of the polarization of the latter by means of an electrical pulse, the fixed polarization magnet (7) being made of an alloy of samarium-cobalt that has a Curie point of about 770° C. and a residual coercive field able to resist the pulse of polarization reversal of the reversible magnet (6) even when the lifter operates on materials at 600-650° C.

The present invention relates to magnetic lifters, and particularly to a lifter with electro-permanent magnets capable of operating safely also on ferromagnetic materials at high temperatures up to 600-650° C. such as billets, blooms, slabs and similar steel mill products.

It is known that magnetic lifters are divided into three classes depending on the type of magnets employed, i.e. permanent magnets, electromagnets and electro-permanent magnets, each type of magnets having its own advantages and drawbacks.

The lifters with permanent magnets have the advantage of an almost negligible power consumption and of a produced magnetic force which is reliably constant and independent of outer supply sources. On the other hand, it is not possible to increase the magnetic force if necessary and the magnets are exceedingly bulky for lifting heavy loads. Furthermore, the load release requires the application of a considerable mechanical power in order to create an air gap between the lifter and the load large enough to reduce the magnetic force to a value smaller than the load weight. Alternatively, the magnets have to be made movable so that they can be moved away from the load, thus decreasing the magnetic attraction.

Still another arrangement for releasing the load from a lifter with permanent magnets is disclosed in FR 2616006 wherein the lifter includes a central iron core enclosed by a pair of permanent magnet blocks secured by iron shoes, laterally joined to reinforcing plates and terminated by lateral poles with one or more compensator coils being disposed on the central core, with a top sliding cover moving on a pair of guide pins surrounded by mechanical force gauges.

In practice, by means of the magnetic flux generated by the compensator coil(s), the magnetic flux generated by the permanent magnets is either cancelled in the load and doubled in the cover to release the load, or cancelled in the cover and doubled in the load to secure the load while the sliding cover moves away from the magnets.

On the contrary, in the lifters with electromagnets it is possible to freely vary the magnetic force by simply adjusting the current flowing in the windings which generate the magnetic field. However, any breakdown, even if very short, of the power supply immediately cancels the magnetic force and thus causes the release of the load. It is therefore evident that safety systems ensuring the supply continuity are essential.

The lifters with electro-permanent magnets succeed in overcoming the main drawbacks of the two above-described types of lifters by combining fixed polarization permanent magnets with permanent magnets of the reversible type, i.e. magnets in which the polarization is easily reversed through the application of an electrical pulse. When the polarization of the magnetic masses, fixed and reversible, results in a North-South-North-South series the magnetic flux is short-circuited within the lifter thus making the latter inoperative, whereas when the polarization of the reversible magnets is in opposition, i.e. in parallel North-South-South-North, the magnetic flux splits up passing through the polar pieces into the ferromagnetic material to be moved and the lifter is operative. The reversible magnet thus generates an adjustable magnetic flux which can also direct the flux of a conventional non-reversible permanent magnet combined therewith, so as to short-circuit the two magnets when the lifter is to be deactivated or arrange them in parallel for activating the lifter.

Since just an electrical pulse but not a continuous supply is needed for reversing the reversible magnet, the safety problems affecting electromagnets are prevented. At the same time, even though permanent magnets are used, it is possible to vary the magnetic force within some limits, and the load release is easy to carry out with a minimum power consumption and without complex structures for moving the magnets.

However, the lifters with electro-permanent magnets manufactured until today have significant use restrictions as far as the temperature of the material that can be safely lifted is concerned. In fact the reversible magnets are usually made of an aluminium-nickel-cobalt alloy (Alnico) that has a Curie point of about 800° C., while the fixed polarization magnets are made of neodymium or ferrite that have a Curie point of about 310° C. and 450° C. respectively. This means that lifters with electro-permanent magnets of Alnico-neodymium operate without problems on ferromagnetic materials with temperatures not greater than 150-200° C., whereas those with magnets of Alnico-ferrite can operate on materials up to 350-400° C.

Another drawback of said lifters with electro-permanent magnets is that in the proximity of the above-cited maximum temperatures the operating point of the fixed magnets made of neodymium or ferrite is located where the residual coercive field is not sufficient to resist the Alnico reversal pulse during the lifter activation phase. In fact it should be noted that during said phase the magnetic flux generated by the Alnico reversal coils is oriented contrary to the polarization of the neodymium or ferrite magnets, whereby if at that moment the residual coercive fields are smaller than the contrary field generated by the coils this will cause in the neodymium or ferrite magnets a gradual yet irreversible decrease of their intrinsic magnetic energy that makes dangerous and unusable the lifter thus manufactured.

Therefore it is an object of the present invention to provide a lifter with electro-permanent magnets that overcomes the above-mentioned drawbacks. Such an object is achieved by means of a lifter provided with fixed polarization magnets made of a samarium-cobalt alloy that has a Curie point of about 770° C. and a residual coercive field able to resist the Alnico reversal pulse even when the lifter operates on materials at high temperatures up to 600-650° C. Other advantageous characteristics are recited in the dependent claims.

The main advantage of this lifter is therefore that of being able to significantly increase the range of the operating temperatures up to values much higher than those that can be reached by present lifters with electro-permanent magnets.

Another important advantage of the lifter according to the present invention is provided by the maximum operating safety guaranteed over time, thanks to the capacity of the fixed magnets to resist the reversible magnets reversal pulses.

Further advantages and characteristics of the lifter according to the present invention will be clear to those skilled in the art from the following detailed description of an embodiment thereof, with reference to the annexed drawings wherein:

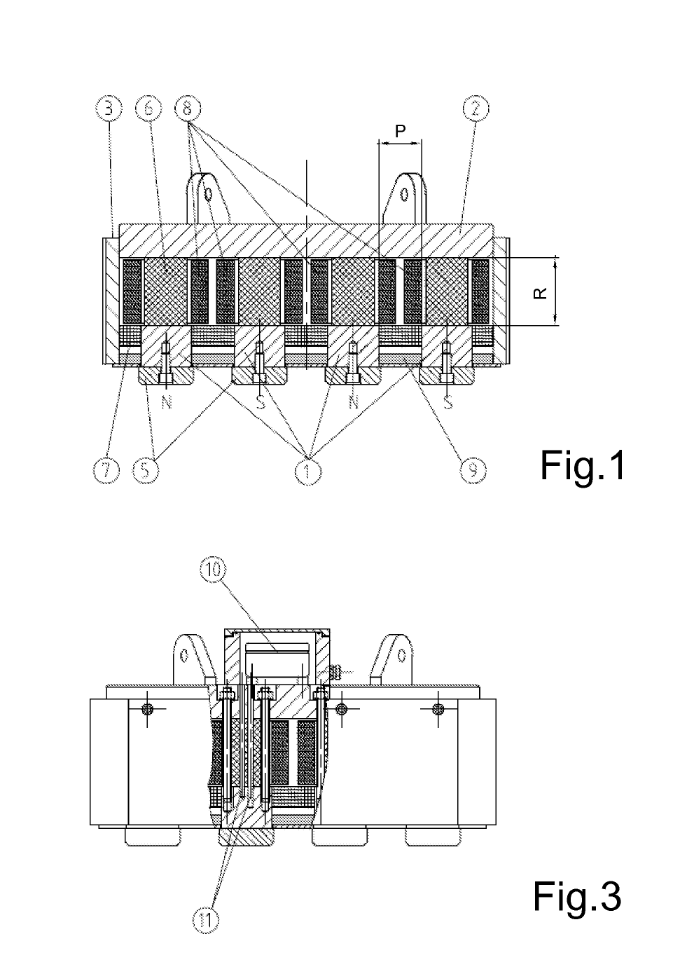

FIG. 1 is a transverse cross-sectional view along the midplane of a lifter according to the present invention, in the inoperative condition;

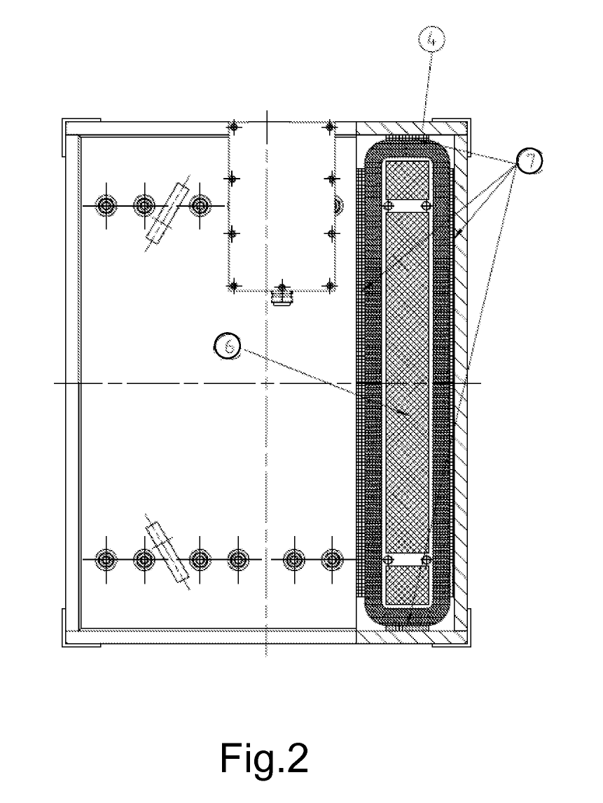

FIG. 2 is a top plan view of the lifter of FIG. 1, with one of the magnetic poles shown in a longitudinal cross-section; and

FIG. 3 is a front view of the lifter of FIG. 1 with a sectioned portion to show some internal details.

With reference to these figures, there is seen that a lifter with electro-permanent magnets according to the present invention conventionally includes an external bearing structure, a plurality of electro-permanent magnets and an adjustment and control circuit.

The bearing structure consists of a top cover 2, provided with couplings for the connection to lifting means (e.g. a crane), two side plates 3, two end plates 4 and a bottom closure plate provided with a heat shield 9 to protect the magnets from the heat radiated by the hot ferromagnetic materials to be lifted. Said structure is obviously made of high magnetic conductivity materials, typically carbon mild steel, in order to minimize the reluctance of the magnetic circuit, same as the circuit poles 1 and the pole pieces 5 possibly applied thereto and protruding below the closure plate.

Each of the electro-permanent magnets includes a reversible magnet 6, arranged on top of a pole 1 and in contact therewith, and a fixed polarization magnet 7 formed by a plurality of blocks placed along the lateral faces of said pole 1. Around the reversible magnet 6 there is arranged a commutation coil 8 that controls the reversal of the polarization thereof, to commute between the condition of inoperative lifter illustrated in FIG. 1 with the poles in series North-South-North-South and the condition of operative lifter with the poles in parallel North-South-South-North.

Each pole 1 is secured to cover 2 through four bars that pass through the reversible magnet 6 and are retained by nuts in suitable seats formed in cover 2 (see FIGS. 2, 3), while the possible pole pieces 5 intended to make contact with the load to be lifted are secured to poles 1 through screws (see FIG. 1).

The adjustment and control circuit preferably includes a device 10 of the type described in EP 0929904 B1, whose contents are incorporated herein by reference. In brief, said device includes for each polarity a first magnetic sensor arranged close to the base of pole 1 and a second magnetic sensor arranged between the fixed magnet 7 and the reversible magnet 6, so as to measure substantially only the magnetic flux passing through the reversible magnet 6, as well as a control unit for processing the signals transmitted by said magnetic sensors (not shown in the drawings) and obtaining the operating point of the lifter on the magnetization curve of the reversible magnet 6.

The above device 10 guarantees absolute safety during any load lifting and transporting operation by checking that the sum of the reversible losses of the magnetic masses 6, 7 and of the decrease in magnetic permeability of the ferromagnetic circuit of the lifter, and in particular of the hot material to be lifted, still allows the lifter to attain the lifting safety coefficient according to the EN 13155 standard (or another similar standard applied in other countries).

Such a device 10 also monitors the efficiency of coils 8 that are preferably made of an aluminium strip or a copper strip so as to minimize their volume and to optimize the thermal dissipation due to Joule effect. Coils 8 are designed such that they can operate correctly with reversal pulses that are either constant in current or constant in voltage, although given the critical operating conditions of high temperature of the material it is preferable to use a constant current apparatus.

The adjustment and control circuit employs also the signals of double thermal probes 11 extending inside each pole 1. The first series of probes 11 indicates a first temperature threshold that allows to carry out the last programmable operations, whereas the second series of probes 11 checks a second level threshold assuring that it is possible to perform safely the last operation and to go on to the programmed cooling of the lifter.

Turning now to the specific novel aspects of the present lifter, the fixed magnets 7 are samarium-cobalt sintered magnets with a Curie point equal to about 770° C., while the reversible magnets 6 are preferably made of an Alnico alloy type VDG or VDGS with a Curie point of about 850° C. In particular, the reversible magnets 6 are produced by taking them to a temperature of about 500° C. and then allowing them to cool slowly so as to cancel the irreversible losses typical of said types of magnetic alloy, equal to about 2%, in order to prevent unbalances during the operation of the lifter since it will have to operate on hot materials. For an optimal operating balance, the present lifter preferably also provides specific dimensional ratios between the Alnico and SmCo magnetic masses of a single North-South magnetic dipole. More specifically, the ratio of the length of the magnetic masses 2R/P illustrated in FIG. 1 is preferably comprised between 2.5 and 3 while the ratio of the cross-section of the magnetic masses is comprised between 0.84 and 0.88.

It should be noted that the length ratio is equal to 2R/P because the reversible magnets 6 are connected in series whereas the various blocks that make up the fixed magnets 7 are in parallel, and vice versa for the same reason the sectional ratio is calculated taking into account the section of only one of the reversible magnets 6 but of both the fixed magnets 7 (whereby the Alnico/SmCo sectional ratio visible in FIG. 2 is actually twice the real ratio).

Also the operation of the above-mentioned lifter provides for an operating method that takes into account the peculiarity of the magnetic materials used for magnets 6, 7 and the high temperature of the material to be lifted.

In particular, in a Cartesian diagram that shows the magnetization curve of magnets 6, 7 indicating the ratio between the residual induction Br and the intensity of the coercive field Hc, the operating method provides for identifying an operating point at the critical moment within a specific range of values. Said critical moment is meant to be the design condition in which the material to be lifted is at the maximum foreseen temperature of 600-650° C. and presents the maximum operating air gap and simultaneously the electro-permanent magnet has reached the maximum operating temperature, i.e. the second level thermal probes 11 are about to intervene.

In this particular situation the value of the Alnico Br/Hc ratio must be comprised between 10 and 15 and at the same time the value of the samarium-cobalt Br/Hc ratio must be comprised between 1 and 2. Maintaining the samarium-cobalt Br/Hc ratio within this range not only ensures the efficiency of the electro-permanent magnet when lifting high temperature material, but also avoids that during the Alnico reversal pulse generated by coil 8 the intensity of the field contrary to the polarization of the fixed SmCo magnet 7 arrives close to the values of the coercive field (Hc) typical of said magnetic compound, so as to safeguard its operational integrity over time.

A lifter with electro-permanent magnets thus manufactured and operated is therefore capable of safely moving materials such as billets, blooms, slabs, etc. at a temperature of 600-650° C. and is suitable for the discharge operating cycle of the cooling plates located at the outlet of the hot rolling line of said products in a steel mill.

It is obvious that the above-described and illustrated embodiment of the lifter according to the invention is just an example susceptible of various modifications. In particular, the exact number, shape and arrangement of the magnetic polarities may vary depending on the specific application, for example by providing a lifter with a single magnetic dipole or three or more magnetic dipoles rather than the two magnetic dipoles illustrated in the present embodiment.

1. Lifter with electro-permanent magnets comprising an external bearing structure closed at the bottom by a plate provided with a heat shield, the circuit poles of said electro-permanent magnets with their possible pole pieces protruding from said bottom plate, each of the electro-permanent magnets being composed of a reversible magnet; arranged on top of one of said poles and in contact therewith, of a fixed polarization magnet formed by a plurality of blocks placed along the lateral faces of said pole, and of a coil arranged around said reversible magnet and suitable to cause the reversal of the polarization of the latter by means of an electrical pulse, wherein the fixed polarization magnet is made of an alloy of samarium-cobalt that has a Curie point of about 770° C. and a residual coercive field able to resist said pulse of polarization reversal of the reversible magnet even when the lifter operates on materials at 600-650° C.

2. Lifter according to claim 1, wherein the reversible magnet is made of an Alnico alloy type VDG or VDGS with a Curie point of about 850° C.

3. Lifter according to claim 2, wherein the reversible magnet is produced by taking it to a temperature of about 500° C. and then allowing it to cool slowly so as to cancel its irreversible losses.

4. Lifter according to claim 1, wherein in a single North-South magnetic dipole the ratio of the length of the reversible magnets and of the fixed polarization magnets is comprised between 2.5 and 3.

5. Lifter according to claim 1,
wherein in a single North-South magnetic dipole the ratio of the cross-section of the reversible magnets and of the fixed polarization magnets is between 0.84 and 0.88.

6. Lifter according to claim 1, wherein the coil is made of an aluminium strip or a copper strip and is able to operate with reversal pulses that are either constant in current or constant in voltage.

7. Lifter according to claim 1, further comprising an adjustment and control circuit comprising double thermal probes which extend in each pole.

8. Lifter according to claim 1, further comprising a device comprising for each polarity a first magnetic sensor arranged close to the base of the pole and a second magnetic sensor arranged between the fixed polarization magnet and the reversible magnet, as well as a control unit for processing the signals transmitted by said magnetic sensors and obtaining the operating point of the lifter on the magnetization curve of the reversible magnet.

9. Method of operating a lifter with electro-permanent magnets according to claim 1, wherein in the design condition in which the material to be lifted is at a temperature of 600-650° C. and presents the maximum operating air gap and simultaneously the electro-permanent magnet has reached the maximum operating temperature, the operating point of the lifter in a Cartesian diagram that shows the magnetization curve of the magnets indicating the ratio between the residual induction and the intensity of the coercive field (Hc) is identified in such a way that the value of said ratio (Br/Hc) for the reversible magnet is comprised between 10 and 15 and at the same time the value of said ratio (Br/Hc) for the fixed polarization magnet is between 1 and 2.
